(19) United States
(12) Patent Application Publication
(10) Pub. No.: US 2015/0316801 A1
(43) Pub. Date: Nov. 5, 2015

(54) DISPLAY PANEL STRUCTURE AND MANUFACTURING METHOD THEREOF

(71) Applicant: HANNSTAR DISPLAY CORPORATION, Taipei City (TW)

(72) Inventors: Jung-Chen LIN, Taipei City (TW); Chun-Chiang CHEN, Taipei City (TW); Chuan-Tzong KUO, Taipei City (TW)

(21) Appl. No.: 14/700,978

(22) Filed: Apr. 30, 2015

(30) Foreign Application Priority Data
Apr. 30, 2014 (CN) 201410182034.7
Apr. 30, 2014 (CN) 201410183240.X

(51) Int. Cl. G02F 1/1339; G02F 1/1343

(52) U.S. Cl. CPC G02F 1/1339; G02F 1/13439

(57) ABSTRACT

A display panel structure and a manufacturing method thereof are disclosed. The display panel structure comprises a first substrate, a second substrate, at least a liquid crystal display (LCD) array, a plurality of LCD units, a plurality of first sealants and at least a second sealant. The second substrate is disposed corresponding to the first substrate. The LCD array is disposed between the first substrate and the second substrate. The LCD units are disposed within the LCD array. The first sealants are disposed around the LCD units, respectively. The second sealant is disposed around the LCD array in annulus. Thereby, the problems of the substrate peeling and fragment occurring in the process of the dorsal plating forming a conducting layer can be improved, and besides, the internal strike effect of the liquid crystal can be restrained, so as to enhance the technical yield.

### CROSS REFERENCE TO RELATED APPLICATIONS

This Non-provisional application claims priority under 35 U.S.C. §119(a) on Patent Application No(s). 201410182034.7 and 201410183240.X filed in People's Republic of China on Apr. 30, 2014, the entire contents of which are hereby incorporated by reference.

### BACKGROUND OF THE INVENTION

1. Field of Invention

This invention relates to a display panel structure and a manufacturing method thereof.

2. Related Art

Liquid crystal display (LCD) apparatuses, having advantages such as low power consumption, less heat, light weight and non-radiation, are widely applied to various electronic products and gradually take the place of cathode ray tube (CRT) display apparatuses.

In general, the liquid crystal display apparatus mainly comprises an LCD panel, a driving module and a backlight module. The LCD panel mainly includes a thin film transistor (TFT) substrate, a color filter (CF) substrate and a liquid crystal layer between the two substrates.

In the conventional manufacturing process of an LCD panel, a plurality of sealants will be disposed on the TFT substrate, and the region within each of the sealants will be filled with liquid crystal, and then a display panel structure including a plurality of LCD units can be obtained after the TFT substrate and the CF substrate are attached to each other under vacuum and the sealants are cured. Then, an additional sealant will be disposed on the edges of the panel structure, and then the processes of the substrate thinning, dorsal plating to form a transparent conducting layer and slicing are implemented to obtain a plurality LCD panels.

However, during the process of the dorsal plating to form a transparent conducting layer, a transparent conducting layer needs to be formed on the outer surface of the CF substrate under vacuum, and the problems of the substrate peeling and fragment will be caused. Moreover, since the sealant is not completely cured when the TFT substrate and the CF substrate are attached to each other under vacuum, the internal strike effect where the liquid crystal molecules strike the sealant (the situation will become more serious with the less panel size) will occur after the attached substrates return to the atmosphere environment. This will result in the leakage of liquid crystal and the yield will be thus reduced.

### SUMMARY OF THE INVENTION

An aspect of the present invention is to provide a display panel structure and manufacturing method thereof whereby the problems of the substrate peeling and fragment while occurring in the process of the dorsal plating to form a transparent conducting layer can be improved, and besides, the internal strike effect can be restrained, so as to enhance the technical yield.

Therefore, a display panel structure according to the invention comprises a first substrate, a second substrate, at least a liquid crystal display (LCD) array, a plurality of LCD units, a plurality of first sealants and at least a second sealant. The second substrate is disposed corresponding to the first substrate. The LCD array is disposed between the first substrate and the second substrate. The LCD units are disposed within the LCD array. The first sealants are disposed around the LCD units. The second sealant is disposed around the LCD array in annulus.

Additionally, a display panel structure according to the invention comprises a first substrate, a second substrate, a plurality of LCD arrays, a plurality of first sealants and at least a second sealant. The second substrate is disposed corresponding to the first substrate. The LCD arrays are disposed between the first substrate and the second substrate in an array, and the LCD arrays includes a plurality of LCD units disposed in an array. The first sealants are disposed around the LCD units. The second sealant connects between the first substrate and the second substrate, and is disposed between the LCD arrays to form a cross shape.

In one embodiment, the display panel structure further comprises at least a transparent conducting layer disposed on an outer surface of the first substrate or second substrate.

In one embodiment, the transparent conducting layer is a patterned polycrystalline transparent conducting layer.

In one embodiment, a plurality of the second sealants are disposed between a plurality of the LCD arrays.

In one embodiment, the second sealant is a double-layered structure around the corresponding LCD array in annulus.

In one embodiment, the second sealants are disposed between edges of the LCD arrays and first substrate.

In one embodiment, the second sealants are disposed separately between the LCD arrays to form a region of cross-like interval.

In one embodiment, the second sealant is a double-layered structure in annulus.

In one embodiment, the second sealants form a shape like “#” between the LCD arrays.

In one embodiment, the second sealants are connected with each other between the LCD arrays to form a cross shape.

In one embodiment, the second sealant is a double-layered structure between edges of the LCD arrays and the first substrate, but a single-layered structure between the LCD arrays.

In one embodiment, each of the LCD units is a fringe field switching (FFS) LCD unit or an in-plane switch (IPS) LCD unit.

In one embodiment, the display panel structure further includes a third sealant which seals edges of the first substrate and second substrate.

In one embodiment, the second sealant is continuous.

In one embodiment, the second sealant is not disposed between edges of the LCD arrays and first substrate.

In one embodiment, the second sealant is a double-layered structure to form a closed space.

In one embodiment, the second sealant is a double-layered and multi-segment structure with at least one opening, and the segment forms a closed space.

In one embodiment, the width of the opening is greater than 3 cm.

In one embodiment, the length of each segment of the second sealant is less than or equal to 30 cm.

Therefore, a manufacturing method of a display panel structure according to the invention comprises steps of: disposing a plurality of first sealants around a plurality of LCD units on a first substrate to form at least an LCD array; forming at least a second sealant on the first substrate, so that the second sealant is disposed around the LCD array; and attaching a second substrate and the first substrate to each other, so that the second sealant connects between the first substrate and the second substrate.

In one embodiment, a manufacturing method of a display panel structure according to the invention comprises steps of: disposing a plurality of first sealants around a plurality of LCD units on a first substrate to form a plurality of LCD arrays; forming a second sealant on the first substrate, so that the second sealant forms a cross shape between the LCD arrays; and attaching a second substrate and the first substrate to each other, so that the second sealant connects between the first substrate and the second substrate.

In one embodiment, the manufacturing method further comprises a step of: forming a third sealant to seal the edges of the first substrate and second substrate.

In one embodiment, the manufacturing method further comprises a step of: forming at least a transparent conducting layer on an outer surface of the first substrate or second substrate.

In one embodiment, in the step of forming at least one transparent conducting layer, the transparent conducting layer is a patterned polycrystalline transparent conducting layer, which is formed by the transformation of an amorphous transparent conducting layer.

In one embodiment, in the step of forming at least one transparent conducting layer, the manufacturing method further comprises steps of: forming the amorphous transparent conducting layer on a surface of the first substrate or second substrate; patterning the amorphous transparent conducting layer by high energy pulse to make the patterned amorphous transparent conducting layer transformed into the patterned polycrystalline transparent conducting layer; and removing the non-patterned amorphous transparent conducting layer by etching.

As mentioned above, in the display panel structure and the manufacturing method thereof according to the invention, the LCD array includes a plurality of LCD units is disposed between the first substrate and the second substrate, each of the first sealants is disposed around the corresponding LCD unit, and the second sealant is disposed around the LCD array in annulus. Moreover, in the display panel structure and the manufacturing method thereof according to the invention, the LCD arrays are disposed between the first substrate and the second substrate in an array, each of the LCD arrays includes a plurality of LCD units which are disposed in an array, and the second sealant connects between the first substrate and the second substrate and is disposed between the LCD arrays to form a cross shape. Thereby, in comparison with the conventional art, the problems of the substrate peeling and fragment occurring during the process of forming the transparent conducting layer for the display panel structure under vacuum can be improved, furthermore, the internal strike effect of the liquid crystal occurring when the first substrate and the second substrate are attached to each other under vacuum and then return to the atmosphere environment can be restrained, so as to enhance the technical yield.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic flowchart of a manufacturing method of a display panel structure of an embodiment of the invention;

FIG. 1B is a schematic flowchart of a manufacturing method of a display panel structure of another embodiment of the invention;

FIGS. 2A and 2B are schematic diagrams showing the processes of the manufacturing method of the display panel structure;

FIG. 2C is a schematic top-view diagram of FIG. 2B;

FIG. 2D is a schematic diagram showing the process of the manufacturing method of the display panel structure of another embodiment of the invention;

FIG. 2E is a schematic top-view diagram of FIG. 2D;

FIG. 3A is a schematic exploded diagram of the display panel structure of another embodiment of the invention;

FIG. 3B is a schematic top-view diagram of FIG. 3A.

FIGS. 4A and 4B are schematic top-view diagrams of the display panel structures of different embodiments of the invention;

FIG. 5A is a schematic flowchart of a manufacturing method of a display panel structure of another embodiment of the invention;

FIG. 5B is a schematic flowchart of a manufacturing method of a display panel structure of another embodiment of the invention;

FIG. 6A is a schematic diagram showing the process of the manufacturing method of a display panel structure of another embodiment of the invention;

FIG. 6B is a schematic top-view diagram of FIG. 6A;

FIG. 6C is a schematic diagram showing the process of the manufacturing method of the display panel structure of another embodiment of the invention;

FIG. 6D is a schematic top-view diagram of FIG. 6C; and

FIG. 7 is a schematic top-view diagram of the display panel structure of another embodiment of the invention.

### DETAILED DESCRIPTION OF THE INVENTION

The present invention will be apparent from the following detailed description, which proceeds with reference to the accompanying drawings, wherein the same references relate to the same elements.

In order to clearly show the features of this invention, each of the first sealant and the second sealant is shown by a dotted line in the following top-view diagrams, but in fact, each of them has a certain width.

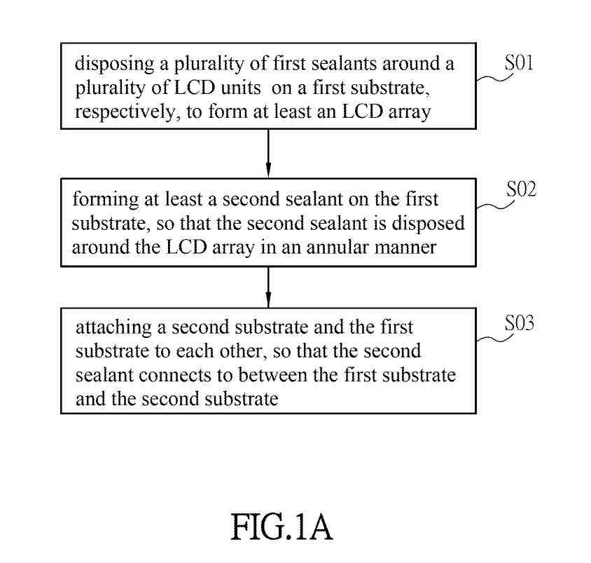

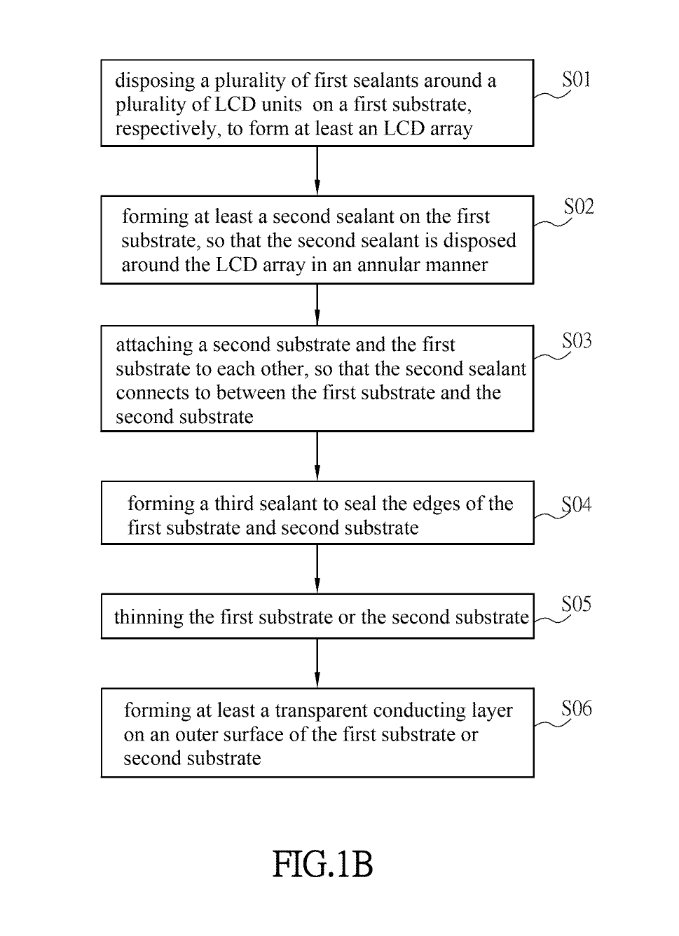

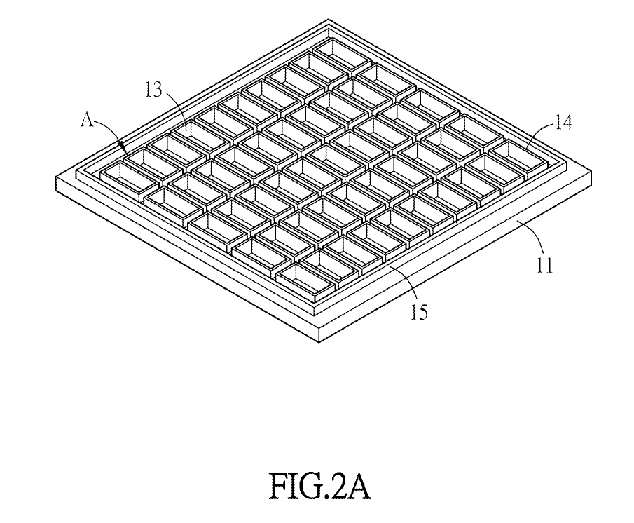

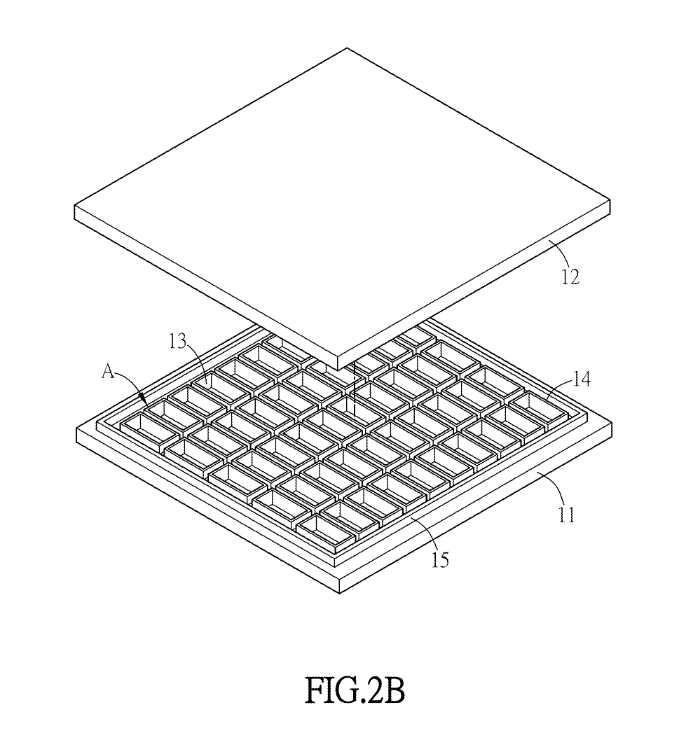

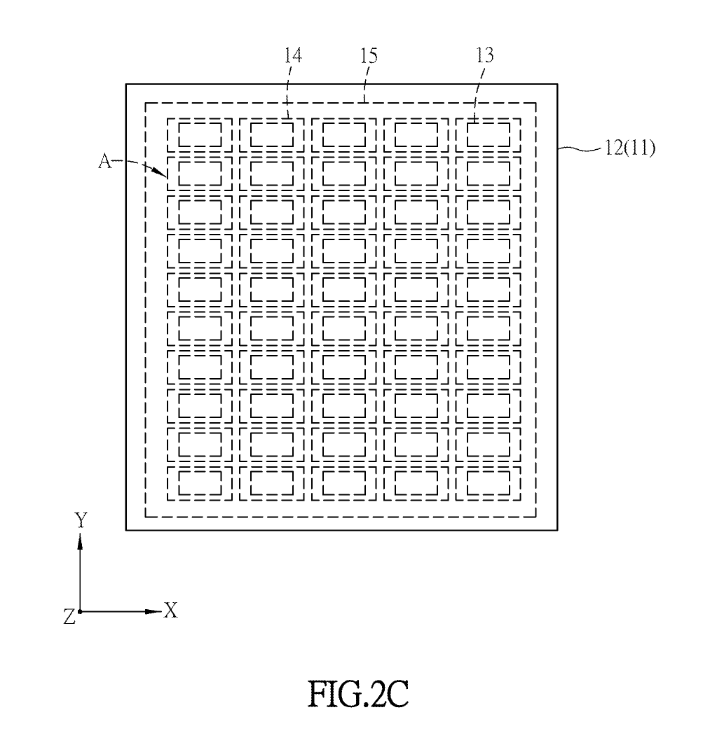

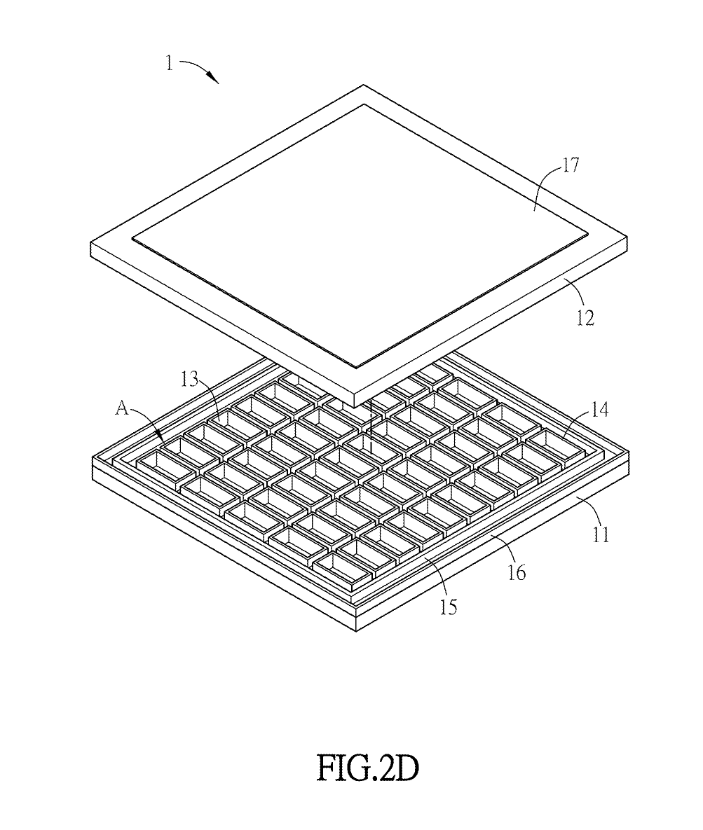

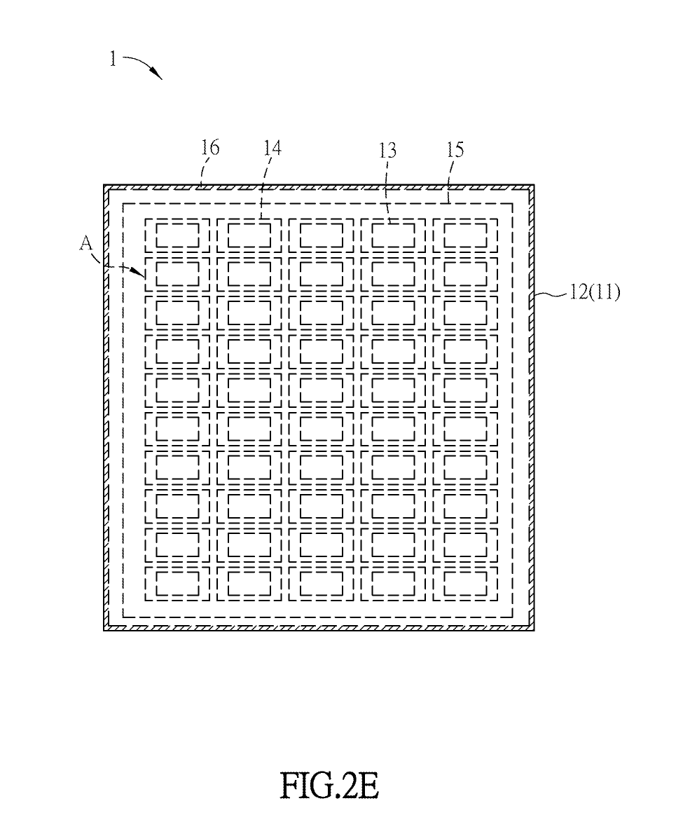

Referring to FIGS. 1A, 2A, 2B, 2C, FIG. 1A is a schematic flowchart of a manufacturing method of a display panel structure of an embodiment of the invention, FIGS. 2A and 2B are schematic diagrams showing the processes of the manufacturing method of the display panel structure, and FIG. 2C is a schematic top-view diagram of FIG. 2B. In order to clearly show the features of this invention, each of the first sealant and the second sealant is shown by a dotted line in the following top-view diagrams of the display panel structure, but in fact, each of them has a certain width.

As shown in FIG. 1A, the manufacturing method of the display panel structure includes the steps S01˜S03.

At first, as shown in FIG. 2A, the step S01 is to dispose a plurality of first sealants 14 around a plurality of liquid crystal display (LCD) units 13 on a first substrate 11 to form at least an LCD array A. The first substrate 11 can be made by transparent material, such as glass, quartz or the like, plastic material, rubber, fiberglass or other polymer materials. Or, the first substrate 11 can be made by opaque material and can be a metal-fiberglass composite plate, a metal-ceramic composite plate, a printed circuit board or other types. The LCD units 13 of this embodiment are disposed in a matrix (two-dimensional array) formed by columns (the direction Y) and rows (the direction X). Each of the LCD units 13 can be a fringe field switching (FFS) LCD unit or an in-plane switch (IPS) LCD unit (for FFS and IPS, a covering electrode disposed on the substrate is required for preventing the static electricity from affecting the display quality), but this invention is not limited thereto. The first sealant 14 can be a thermo-curing adhesive, a photo curing-adhesive or their combination. Herein for example, the first sealant 14 is a photo-curing adhesive (such as UV adhesive), and is, for example but not limited to, formed on the first substrate 11 by coating under atmosphere environment. Each of the first sealants 14 is disposed in annulus to form a containing space, and therefore the liquid crystal molecules can be filled into the containing space bounded by the first sealant 14 to form an LCD unit 13. The liquid crystal molecules are, for example but not limited to, filled in the regions bounded by the first sealants 14 by the one drop filling (ODF) process, so that the first sealants 14 are disposed around the LCD units 13.

Then, the step S02 is to form at least a second sealant 15 on the first substrate 11, so that the second sealant 15 is disposed around the LCD array A in annulus. Herein, a single second sealant 15 is illustrated as an example. Herein, a single LCD array A and a single second sealant 15 are illustrated as an example. The second sealant 15 can be a thermo-curing adhesive, a photo-curing adhesive or their combination. Herein for example, the second sealant 15 is the combination of a thermo-curing adhesive and a photo-curing adhesive. For example, the second sealant 15 can be formed on the first substrate 11 by coating under atmosphere environment, and is disposed around the LCD units 13 of the LCD array A in annulus. In other words, the second sealant 15 is continuous, which means the second sealant 15 has a closed shape without a break and is formed on the outside of the LCD units 13 which are disposed in an array, so that the first substrate 11, the second substrate 12 and the second sealant 15 form a closed space.

Then, as shown in FIGS. 2B and 2C, the step S03 is to attach a second substrate 12 and the first substrate 11 to each other, so that the second sealant 15 connects to between the first substrate 11 and the second substrate 12. The second substrate 12 also can be made by transparent material, such as glass, quartz or the like, plastic material, rubber, fiberglass or other polymer materials. Or, the second substrate 12 can be made by opaque material and can be a metal-fiberglass composite plate, a metal-ceramic composite plate, a printed circuit board or other types. In this embodiment, the material of the first substrate 11 and second substrate 12 is transparent glass for example. The first substrate 11 and the second substrate 12 can be attached to each other under vacuum. The first substrate 11 can include at least a TFT array and the second substrate 12 can include at least a CF array and a black matrix. However, in other embodiments, the color filter layer of the CF array or the black matrix may be disposed on the first substrate 11 for making a COA (color filter on array) substrate or a BOA (BM on array) substrate. To be noted, the above-mentioned structures are just for example but not for limiting the scope of the invention. After the step S03, a curing technique can be implemented to cure the first sealant 14 and the second sealant 15 (not shown). Herein for example, the second sealant 15 can be illuminated by UV light under atmosphere environment (not complete curing), and then the baking by oven will completely cure the first sealant 14 and the second sealant 15.

In addition, referring to FIGS. 1B, 2D and 2E, FIG. 1B is a schematic flowchart of a manufacturing method of a display panel structure of another embodiment of the invention, FIG. 2D is a schematic diagram showing the process of the manufacturing method of the display panel structure of another embodiment of the invention, and FIG. 2E is a schematic top-view diagram of FIG. 2D.

In addition to the steps S01˜S03, as shown in FIG. 1B, the manufacturing method of the display panel structure can further include the steps S04˜S06.

As shown in FIGS. 2D and 2E, the step S04 is to form a third sealant 16 to seal the edges of the first substrate 11 and second substrate 12. The third sealant 16 also can be a thermo-curing adhesive, a photo-curing adhesive or their combination. Herein for example, the third sealant 16 is a photo-curing adhesive (such as UV adhesive) and can be formed on the edges of the first substrate 11 and second substrate 12 by coating. However, this invention is not limited thereto. Thereby, the chemical agent used in the subsequent process can be prevented from damaging the internal structure of the display panel structure 1.

After the step S04 of forming the third sealant 16 and before the step S05, another curing technique can be implemented to cure the third sealant 16 (not shown). Then, the step S05 of the substrate thinning is to thin the first substrate 11 or the second substrate 12. Herein for example, the grinding, polishing or etching treatment can be used to reduce the thickness of each of the first substrate 11 and second substrate 12 as less than 0.4 mm.

Then, the step S06 is to form at least a transparent conducting layer 17 on an outer surface of the first substrate 11 or second substrate 12. Herein for example, the transparent conducting layer 17 can be formed on the outer surface of the second substrate 12 under vacuum. The material of the transparent conducting layer 17 is, for example but not limited to, indium-tin oxide (ITO), indium-zinc oxide (IZO) or other kinds of material. If the LCD units 13 of the display panel structure 1 are FFS or IPS LCD units, the transparent conducting layer 17 can act as the electrostatic protection layer of the LCD units 13 so as to enhance the electrostatic protection function of the display panel structure 1. If the LCD units 13 are touch LCD units 13 (FFS or IPS), the display panel structure 1 can be applied to the on-cell touch panel for example and the transparent conducting layer 17 can be a touch sensing layer (which can include the driving electrode and sensing electrode, not shown). The transparent conducting layer 17 can be a patterned polycrystalline transparent conducting layer (the pattern is not shown in the figure), which can be formed from the transformation of an amorphous transparent conducting layer. To be noted, the method of forming the patterned polycrystalline transparent conducting layer can include the following steps of: forming at least an amorphous transparent conducting layer (material such as ITO) on the surface of the second substrate 12; patterning the amorphous transparent conducting layer by high energy pulse to make the patterned amorphous transparent conducting layer transformed into the patterned polycrystalline transparent conducting layer; and removing the non-patterned amorphous transparent conducting layer by etching. In practice, for example, the amorphous transparent conducting layer may be formed on the outer surface of the second substrate 12 by sputtering and the thickness thereof is between 200 Å and 800 Å. Then, the excimer laser annealing (ELA) treatment is implemented to the amorphous transparent conducting layer, wherein the high energy pulse directly patterns the amorphous transparent conducting layer and the amorphous transparent conducting layer is thus exposed to the high temperature in a very short time so as to be transformed into the patterned polycrystalline transparent conducting layer. Subsequently, the etching technique is used, wherein the chemical agent (such as oxalic acid) which can only etch the amorphous material is used to remove the non-patterned amorphous transparent conducting layer to obtain the patterned polycrystalline transparent conducting layer. The polycrystalline transparent conducting layer has better electrical conductivity than the amorphous transparent conducting layer. Moreover, the patterning achieved by the laser can save a step of photoresist technique, such as exposure and development. After forming the transparent conducting layer 17, a slicing technique will be further implemented (not shown) to obtain the LCD panel or touch display panel including a plurality of LCD units 13.

Through the demonstration, in the display panel structure 1 made by the manufacturing method of this embodiment, in comparison with the conventional art, the second sealant 15 is disposed around the LCD array A in annulus. Thereby, the problems of the substrate peeling and fragment occurring during the process of forming the transparent conducting layer on the outer surface of the second substrate 12 under vacuum can be improved, furthermore, the internal strike effect where the liquid crystal molecules strike the sealant occurring when the first substrate 11 and the second substrate 12 are attached to each other under vacuum and the first sealant 15 is not cured can be restrained, so as to enhance the technical yield.

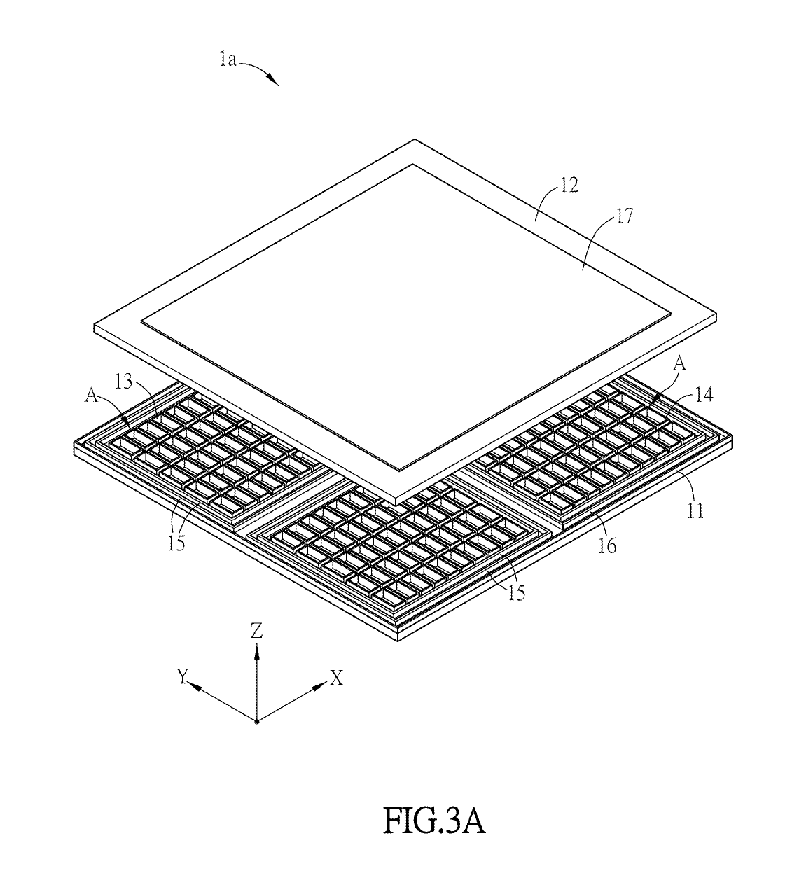

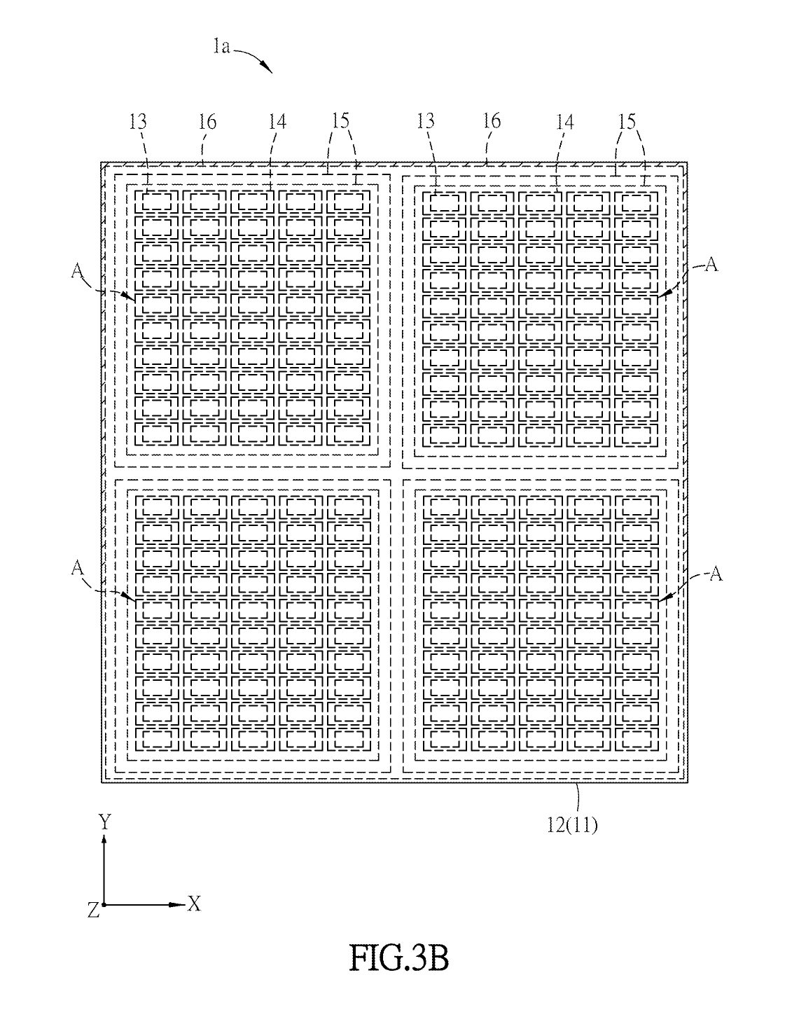

Referring to FIGS. 3A and 3B, FIG. 3A is a schematic exploded diagram of the display panel structure 1a of another embodiment of the invention, and FIG. 3B is a schematic top-view diagram of FIG. 3A.

The main difference between the display panel structure 1a and the display panel structure 1 in FIG. 2D is that the display panel structure 1a includes four LCD arrays A and four second sealants 15. The LCD arrays A are arranged into a two-dimensional matrix, and each of the second sealants 15 is disposed around the LCD units 13 of the corresponding array A in annulus and encircles the corresponding LCD array A, so that the display panel structure 1a is a four-section board. Each of the second sealants 15 is a double-layered structure and disposed around the corresponding LCD array A. Moreover, the second sealants 15 are disposed separately, so that a region of interval exists between two adjacent ones of the second sealants 15. In other words, the second sealants 15 are arranged into an array formed by columns (the direction Y) and rows (the direction X), and the two adjacent second sealants 15 along the column or row direction form the region of interval therebetween. Herein, as shown in FIG. 3B, between the LCD arrays A, the two adjacent second sealants 15 along the direction Y are disposed separately and the two adjacent second sealants 15 along the direction X are also disposed separately, so that the region of cross-like interval is formed on the four-section board.

Other technical features of the display panel structure 1a can be comprehended by referring to the display panel structure 1, so the related illustration is omitted here for conciseness.

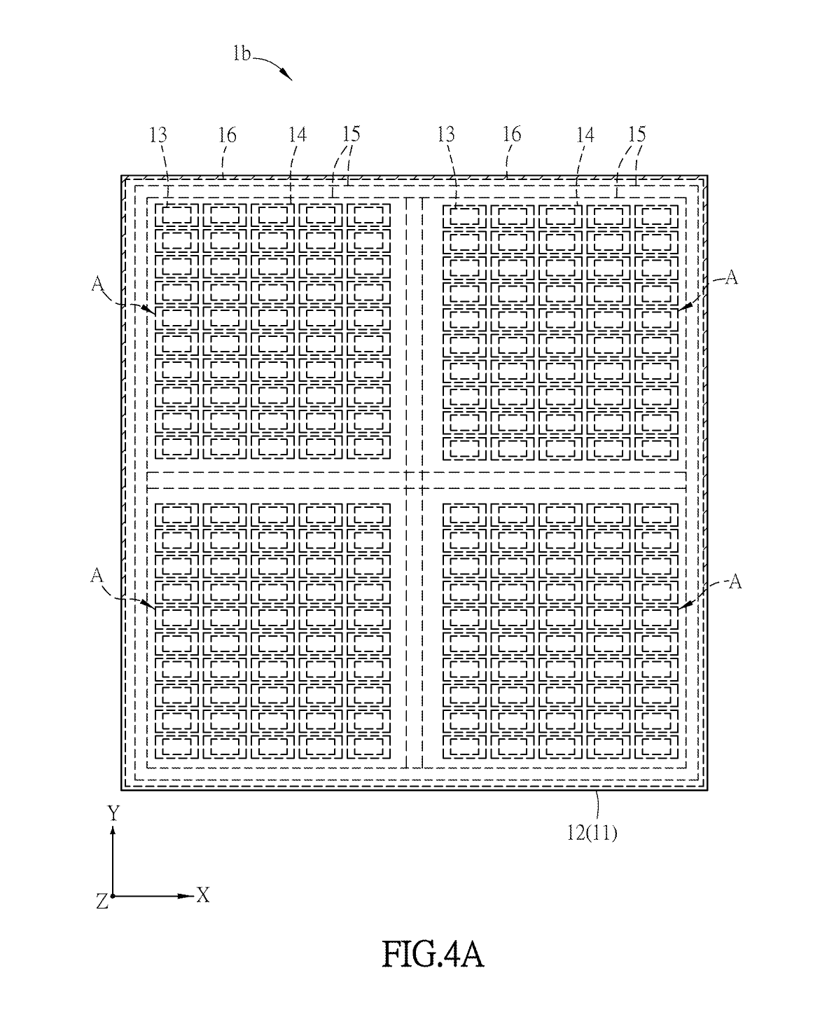

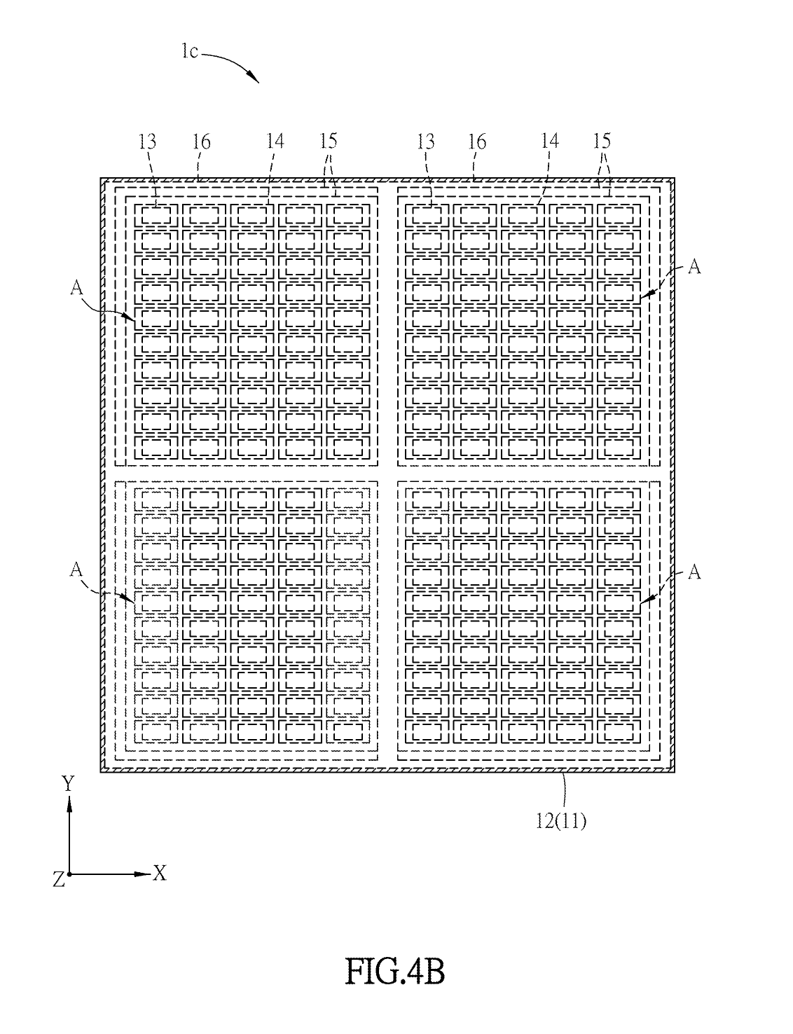

Refer to FIGS. 4A and 4B, which are schematic top-view diagrams of the display panel structures 1b, 1c as different embodiments of the invention.

As shown in FIG. 4A, the main difference from the display panel structure 1a is that the adjacent second sealants 15 disposed between the edges of the LCD arrays A and first substrate 11 of the display panel structure 1b are connected with each other, so that the second sealants 15 are disposed into two loops. Besides, each of the second sealants 15 disposed between the LCD arrays A is a single-layered structure and connected with the corresponding peripheral second sealant 15, and the middle part of the four-section board forms a shape like “#”.

As shown in FIG. 4B, the display panel structure 1c also includes four LCD arrays A and four second sealants 15. However, the main difference between the display panel structure 1c and the display panel structure 1a is that each of the second sealants 15 disposed between the edges of the LCD array A and first substrate 11 is a double-layered structure but each of the second sealants 15 disposed between the LCD arrays A is a single-layered structure.

Other technical features of the display panel structures 1b, 1c can be comprehended by referring to the display panel structure 1a, so the related illustration is omitted here for conciseness.

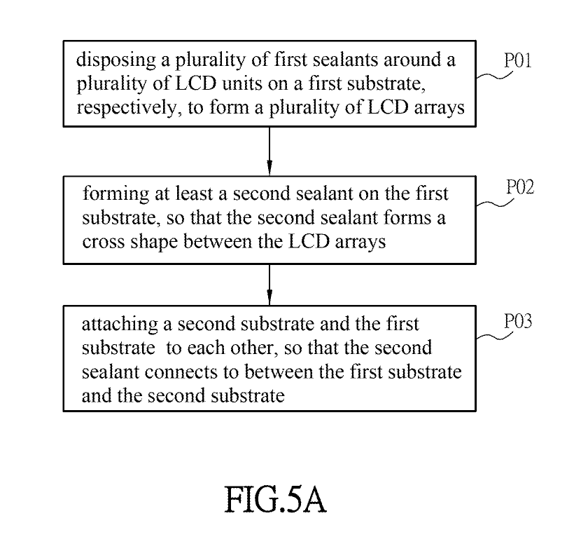

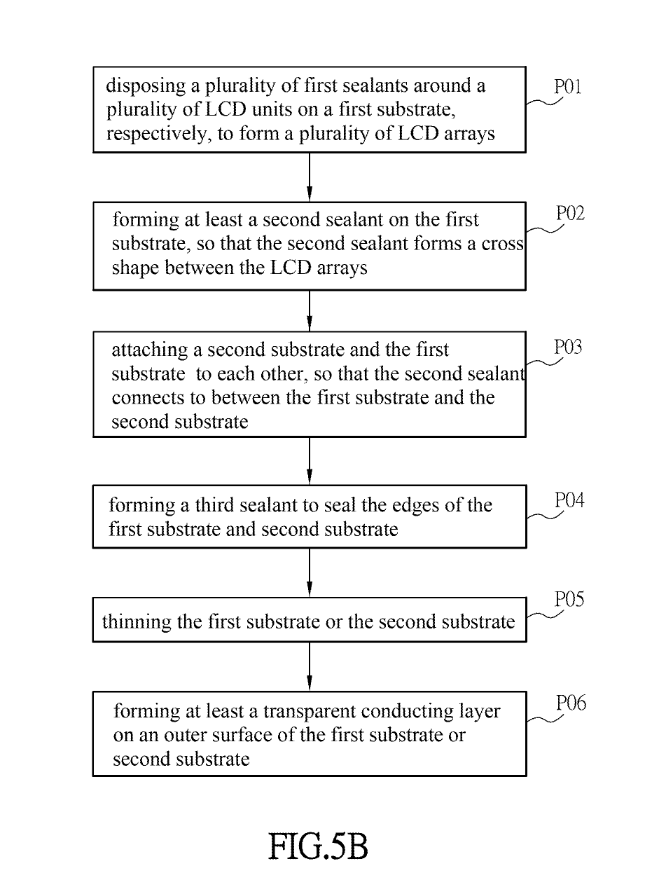

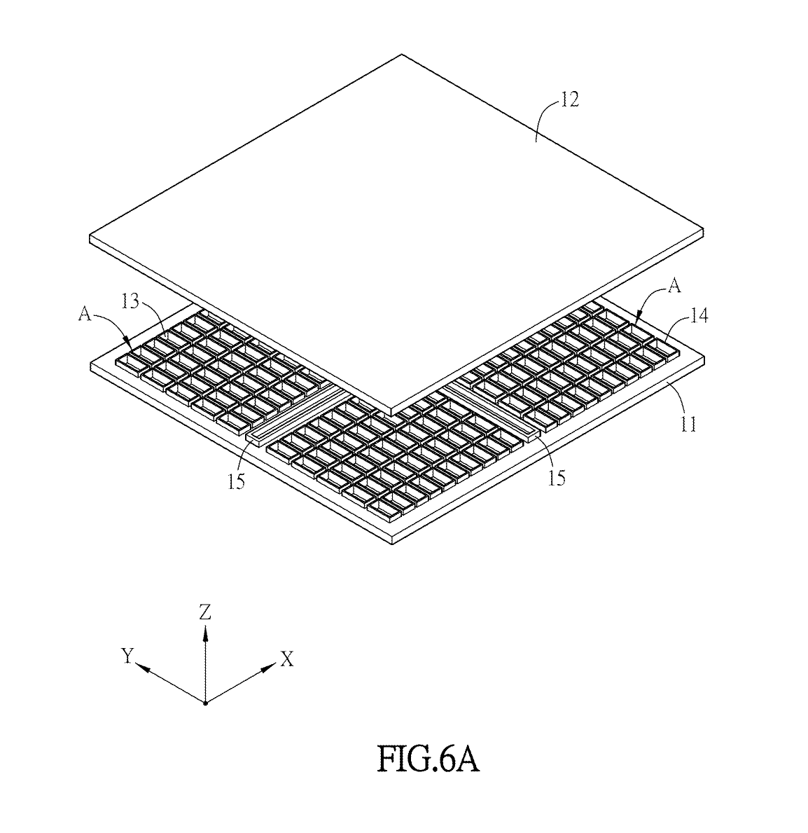

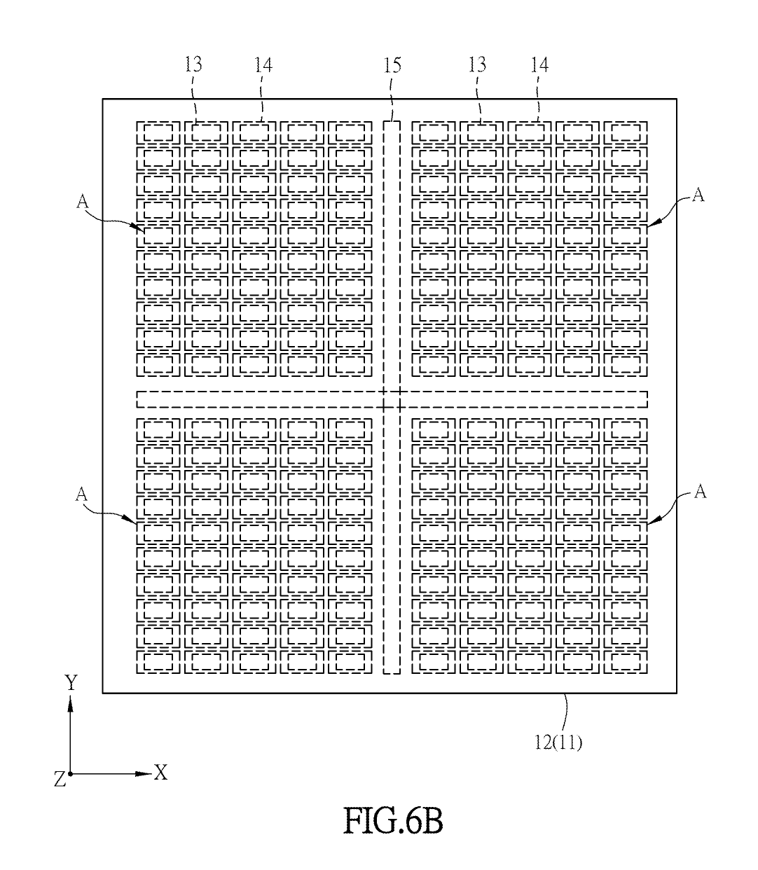

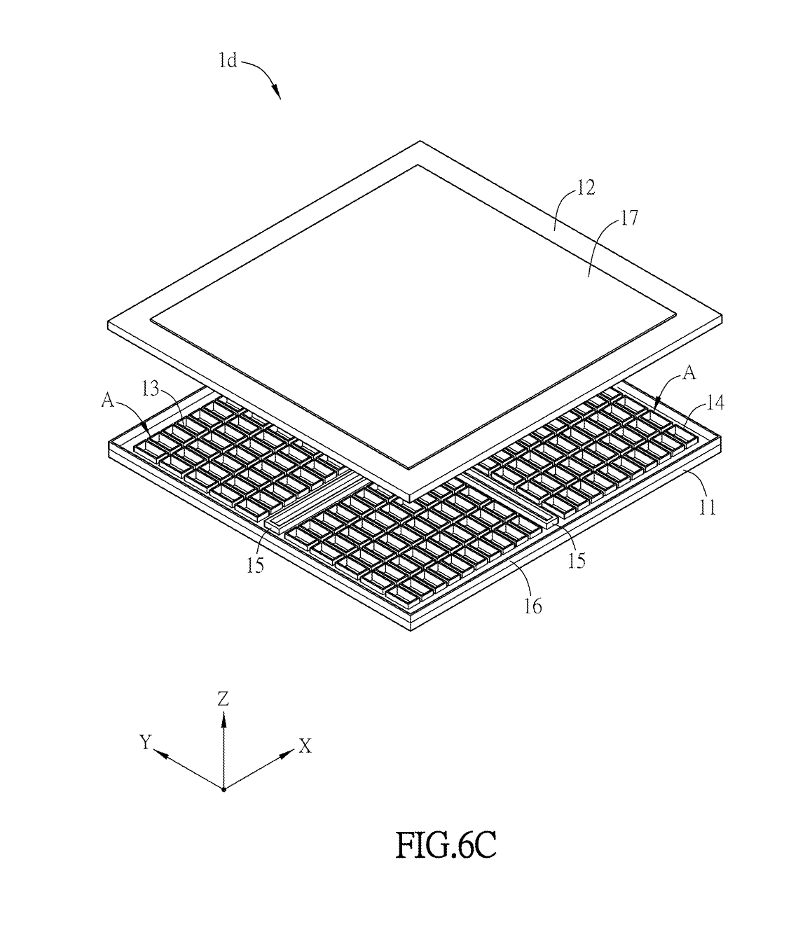

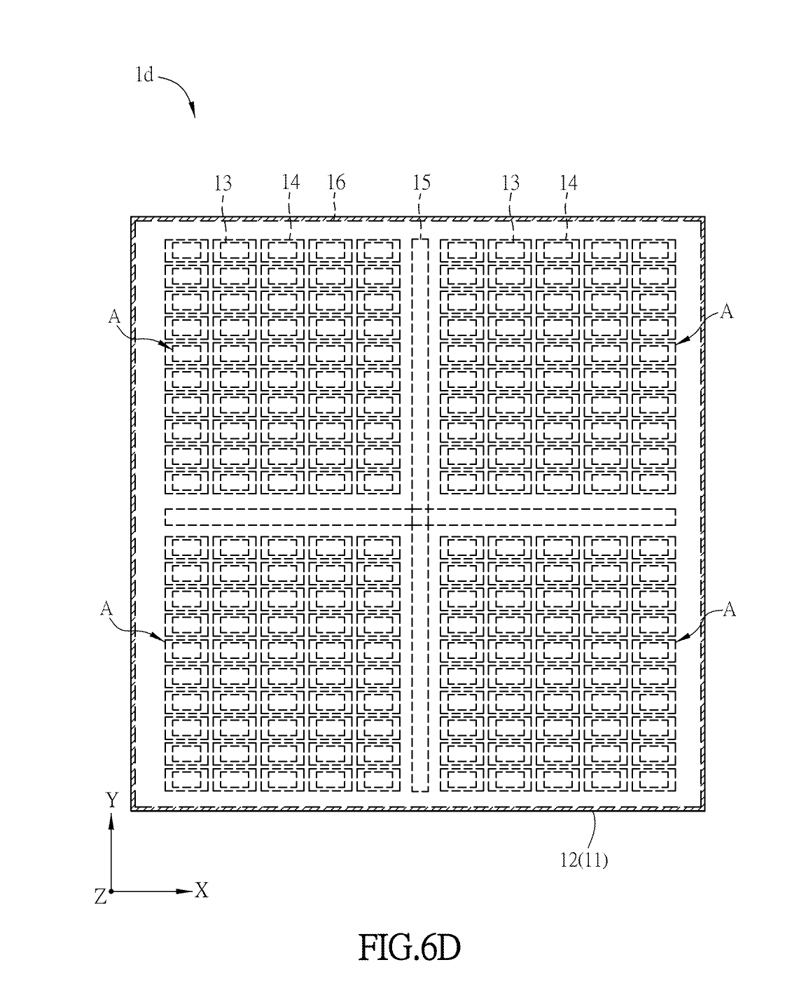

Referring to FIGS. 5A, 6A and 6B, FIG. 5A is a schematic flowchart of a manufacturing method of a display panel structure of another embodiment of the invention, FIG. 6A is a schematic diagram showing the process of the manufacturing method of a display panel structure of another embodiment of the invention, and FIG. 6B is a schematic top-view diagram of FIG. 6A.

As shown in FIG. 5A, the manufacturing method of the display panel structure includes the steps P01˜P03.

At first, as shown in FIGS. 6A and 6B, the step P01 is to dispose a plurality of first sealants 14 around a plurality of liquid crystal display (LCD) units 13 on a first substrate 11 to form a plurality of LCD arrays A. The first substrate 11 can be made by transparent material, such as glass, quartz or the like, plastic material, rubber, fiberglass or other polymer materials. Or, the first substrate 11 can be made by opaque material and can be a metal-fiberglass composite plate, a metal-ceramic composite plate, a printed circuit board or other types. Herein for example, four LCD arrays A are formed on the first substrate 11 and arranged into a two-dimensional array (2*2). Besides, the LCD units 13 of each LCD array A are also disposed in a two-dimensional array formed by columns (the direction Y) and rows (the direction X). Each of the LCD units 13 can be a fringe field switching (FFS) LCD unit or an in-plane switch (IPS) LCD unit (for FFS and IPS, a covering electrode disposed on the substrate is required for preventing the static electricity from affecting the display quality), but this invention is not limited thereto.

The first sealant 14 can be a thermo-curing adhesive, a photo curing-adhesive or their combination. Herein for example, the first sealant 14 is a photo-curing adhesive (such as UV adhesive), and is, for example but not limited to, formed on the first substrate 11 by coating under atmosphere environment. Each of the first sealants 14 is disposed in annulus to form a containing space, and therefore the liquid crystal molecules can be filled into the containing space bounded by the first sealant 14 to form an LCD unit 13. The liquid crystal molecules are, for example but not limited to, filled in the regions bounded by the first sealants 14 by the one drop filling (ODF) process, so that the first sealants 14 are disposed around the LCD units 13 to form a two-dimensional LCD arrays A.

Then, the step P02 is to form at least a second sealant 15 on the first substrate 11, so that the second sealant 15 forms a cross shape between the LCD arrays A. Herein for example, the second sealant 15 is a double-layered continuous structure and is just disposed between the LCD arrays A and formed into a closed cross shape but not disposed between the edges of the LCD arrays A and first substrate 11. The second sealant 15 can be a thermo-curing adhesive, a photo-curing adhesive or their combination. Herein for example, the second sealant 15 is the combination of a thermo-curing adhesive and a photo-curing adhesive. For example, the second sealant 15 can be formed on the first substrate 11 by coating under atmosphere environment, and can form a cross shape between the LCD arrays A. In other words, the second sealant 15 of this embodiment is just formed between the LCD arrays A, and since the LCD arrays A are arranged in a two-dimensional array (2*2), the double-layered structure of the second sealant 15 forms a cross shape between the LCD arrays A.

Then, the step P03 is to attach a second substrate 12 and the first substrate 11 to each other, so that the second sealant 15 connects to between the first substrate 11 and the second substrate 12. The second substrate 12 also can be made by transparent material, such as glass, quartz or the like, plastic material, rubber, fiberglass or other polymer materials. Or, the second substrate 12 can be made by opaque material and can be a metal-fiberglass composite plate, a metal-ceramic composite plate, a printed circuit board or other types. In this embodiment, the material of the first substrate 11 and second substrate 12 is transparent glass for example. The first substrate 11 and the second substrate 12 can be attached to each other under vacuum. The first substrate 11 can include at least a TFT array and the second substrate 12 can include at least a CF array and a black matrix. However, in other embodiments, the color filter layer of the CF array or the black matrix may be disposed on the first substrate 11 for making a COA (color filter on array) substrate or a BOA (BM on array) substrate. To be noted, the above-mentioned structures are just for example but not for limiting the scope of the invention. After the step P03, a curing technique can be implemented to cure the first sealant 14 and the second sealant 15 (not shown). Herein for example, the second sealant 15 can be illuminated by UV light under atmosphere environment (not complete curing), and then the baking by oven will completely cure the first sealant 14 and the second sealant 15.

In addition, referring to FIGS. 5B, 6C and 6D, FIG. 5B is a schematic flowchart of a manufacturing method of a display panel structure of another embodiment of the invention, FIG. 6C is a schematic diagram showing the process of the manufacturing method of the display panel structure of another embodiment of the invention, and FIG. 6D is a schematic top-view diagram of FIG. 6C.

In addition to the steps P01˜P03, as shown in FIG. 5B, the manufacturing method of the display panel structure can further include the steps P04˜P06.

As shown in FIGS. 6C and 6D, the step P04 is to form a third sealant 16 to seal the edges of the first substrate 11 and second substrate 12. The third sealant 16 also can be a thermo-curing adhesive, a photo-curing adhesive or their combination. Herein for example, the third sealant 16 is a photo-curing adhesive (such as UV adhesive) and can be formed on the edges of the first substrate 11 by coating so as to seal the first substrate 11 and second substrate 12. However, this invention is not limited thereto. Thereby, the chemical agent used in the subsequent process can be prevented from damaging the internal structure of the display panel structure 1d.

After the step P04 of forming the third sealant 16 and before the step P05, another curing technique can be implemented to cure the third sealant 16 (not shown). Then, the step P05 of the substrate thinning is to thin the first substrate 11 or the second substrate 12. Herein for example, the grinding, polishing or etching treatment can be used to reduce the thickness of each of the first substrate 11 and second substrate 12 as less than 0.4 mm.

Then, the step P06 is to form at least a transparent conducting layer 17 on an outer surface of the first substrate 11 or second substrate 12. Herein for example, the transparent conducting layer 17 can be formed on the outer surface of the second substrate 12 under vacuum. The material of the transparent conducting layer 17 is, for example but not limited to, indium-tin oxide (ITO), indium-zinc oxide (IZO) or other kinds of material. If the LCD units 13 of the display panel structure 1d are FFS or IPS LCD units, the transparent conducting layer 17 can act as the electrostatic protection layer of the LCD units 13 so as to enhance the electrostatic protection function of the display panel structure 1d. If the LCD units 13 are touch LCD units 13 (FFS or IPS), the display panel structure 1d can be applied to the on-cell touch panel for example and the transparent conducting layer 17 can be a touch sensing layer (can include the driving electrode and sensing electrode, not shown). The transparent conducting layer 17 can be a patterned polycrystalline transparent conducting layer (the pattern is not shown in the figure), which can be formed from the transformation of an amorphous transparent conducting layer. To be noted, the method of forming the patterned polycrystalline transparent conducting layer can include the following steps of: forming at least an amorphous transparent conducting layer (material such as ITO) on the surface of the second substrate 12; patterning the amorphous transparent conducting layer by high energy pulse to make the patterned amorphous transparent conducting layer transformed into the patterned polycrystalline transparent conducting layer; and removing the non-patterned amorphous transparent conducting layer by etching. In practice, for example, the amorphous transparent conducting layer may be formed on the outer surface of the second substrate 12 by sputtering and the thickness thereof is between 200 Å and 800 Å. Then, the excimer laser annealing (ELA) treatment is implemented to the amorphous transparent conducting layer, wherein the high energy pulse directly patterns the amorphous transparent conducting layer and the amorphous transparent conducting layer is thus exposed to the high temperature in a very short time so as to be transformed into the patterned polycrystalline transparent conducting layer. Subsequently, an etching technique is used, wherein the chemical agent (such as oxalic acid) which just can etch the amorphous material is used to remove the non-patterned amorphous transparent conducting layer to obtain the patterned polycrystalline transparent conducting layer. The polycrystalline transparent conducting layer has better electrical conductivity than the amorphous transparent conducting layer. Moreover, the patterning achieved by the laser can save a step of photoresist technique, such as exposure and development. After forming the transparent conducting layer 17, a slicing technique will be further implemented (not shown) to obtain the LCD panel or touch display panel including a plurality of LCD units 13.

Through the demonstration, in the display panel structure 1d made by the manufacturing method of this embodiment, in comparison with the conventional art, the second sealant 15 connects between the first substrate 11 and the second substrate 12 and is disposed between the LCD arrays A and formed into a cross shape. Thereby, the problems of the substrate peeling and fragment occurring during the process of forming the transparent conducting layer 17 on the outer surface of the second substrate 12 under vacuum can be improved, and besides, the internal strike effect of the liquid crystal occurring before the first sealant 15 is not cured can be restrained, so as to enhance the technical yield.

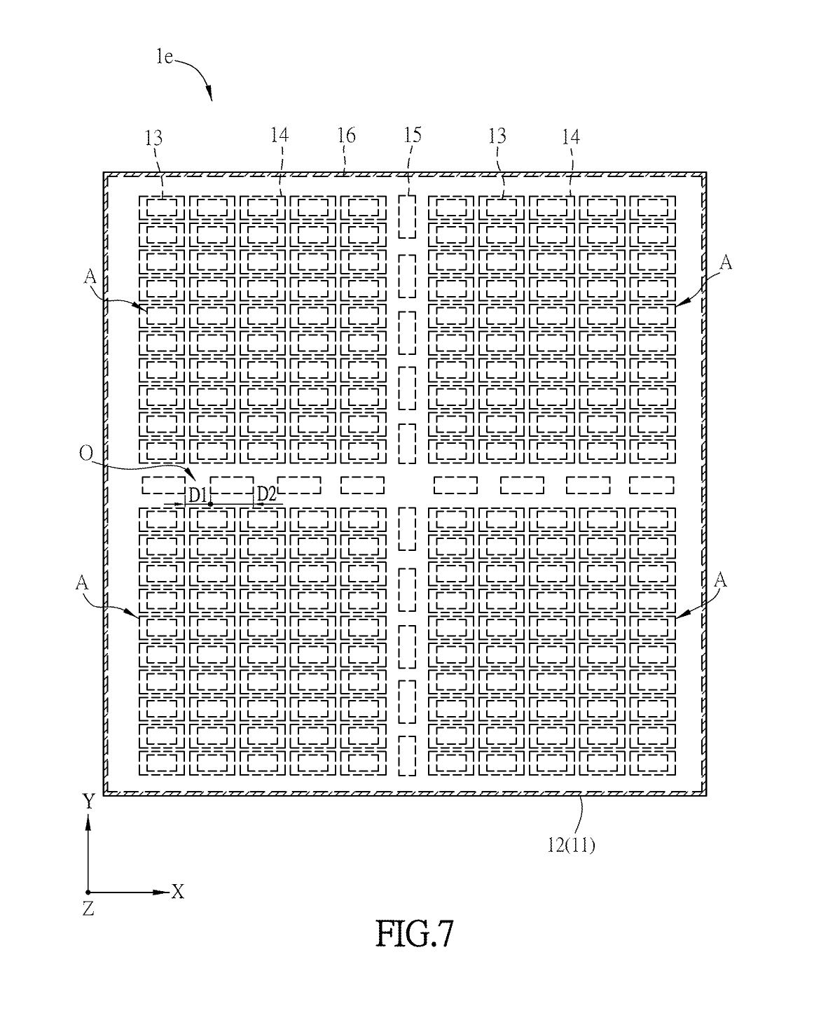

Refer to FIG. 7, which is a schematic top-view diagram of the display panel structure 1e of another embodiment of the invention.

The display panel structure 1e also includes four LCD arrays A and a second sealant 15. However, the main difference from the display panel structure 1d of FIG. 6D is that the second sealant 15 of the display panel structure 1e is a double-layered and multi-segment structure and includes at least an opening O (an opening O exists between one segment and another segment). Herein for example, each of the segments of the second sealant 15 forms a closed space and there are a plurality of openings O. The distance D1 between the two adjacent segments of the second sealant 15 can be greater than 3 cm (i.e. the opening O between the two adjacent segments is at least 3 cm). Besides, the length D2 of each segment of the second sealant 15 can be less than or equal to 30 cm (i.e. D2≦30 cm).

Other technical features of the display panel structure 1e can be comprehended by referring to the display panel structure 1d, so the related illustration is omitted here for conciseness.

Summarily, in the display panel structure and the manufacturing method thereof according to the invention, the LCD array including a plurality of LCD units is disposed between the first substrate and the second substrate, each of the first sealants is disposed around the corresponding LCD unit, and the second sealant is disposed around the LCD array in annulus. Moreover, in the display panel structure and the manufacturing method thereof according to the invention, the LCD arrays are disposed between the first substrate and the second substrate in an array, each of the LCD arrays includes a plurality of LCD units which are disposed in an array, and the second sealant connects to between the first substrate and the second substrate and is disposed between the LCD arrays and formed into a cross shape. Thereby, in comparison with the conventional art, the problems of the substrate peeling and fragment occurring during the process of forming the transparent conducting layer for the display panel structure under vacuum can be improved, and besides, the internal strike effect of the liquid crystal occurring when the first substrate and the second substrate are attached to each other under vacuum and then return to the atmosphere environment can be restrained, so as to enhance the technical yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel structure, comprising:
a first substrate;
a second substrate disposed corresponding to the first substrate;
at least a liquid crystal display (LCD) array disposed between the first substrate and the second substrate;
a plurality of LCD units disposed within the LCD array;
a plurality of first sealants disposed around the LCD units; and
at least a second sealant disposed around the LCD array in annulus.

2. The display panel structure as recited in claim 1, wherein a plurality of the second sealants are disposed between a plurality of the LCD arrays.

3. The display panel structure as recited in claim 2, wherein the second sealant is a double-layered structure around the corresponding LCD array in annulus.

4. The display panel structure as recited in claim 2, wherein the second sealants are disposed between edges of the LCD arrays and first substrate.

5. The display panel structure as recited in claim 2, wherein the second sealants are disposed separately between the LCD arrays to form a region of cross-like interval.

6. The display panel structure as recited in claim 5, wherein the second sealant is a double-layered structure in annulus.

7. The display panel structure as recited in claim 6, wherein the second sealants form a shape like “#” between the LCD arrays.

8. The display panel structure as recited in claim 2, wherein the second sealants are connected with each other between the LCD arrays to form a cross shape.

9. The display panel structure as recited in claim 2, wherein the second sealant is a double-layered structure between edges of the LCD arrays and the first substrate, but a single-layered structure between the LCD arrays.

10. The display panel structure as recited in claim 1, further comprising:
a third sealant which seals edges of the first substrate and second substrate.

11. A display panel structure, comprising:
a first substrate;
a second substrate disposed corresponding to the first substrate;
a plurality of LCD arrays disposed between the first substrate and the second substrate in an array, the LCD arrays including a plurality of LCD units disposed in an array;
a plurality of first sealants disposed around the LCD units; and
at least a second sealant connecting between the first substrate and the second substrate, wherein the second sealant is disposed between the LCD arrays to form a cross shape.

12. The display panel structure as recited in claim 11, wherein the second sealant is continuous.

13. The display panel structure as recited in claim 11, wherein the second sealant is not disposed between edges of the LCD arrays and first substrate.

14. The display panel structure as recited in claim 11, wherein the second sealant is a double-layered structure to form a closed space.

15. The display panel structure as recited in claim 11, wherein the second sealant is a double-layered and multi-segment structure with at least one opening, and the segment forms a closed space.

16. The display panel structure as recited in claim 11, further comprising:
at least a transparent conducting layer disposed on an outer surface of the first substrate or second substrate.

17. A manufacturing method of a display panel structure, comprising steps of:
disposing a plurality of first sealants around a plurality of LCD units on a first substrate to form a plurality of LCD arrays;
forming a second sealant on the first substrate, so that the second sealant forms a cross shape between the LCD arrays; and
attaching a second substrate and the first substrate to each other, so that the second sealant connects between the first substrate and the second substrate.

18. The manufacturing method as recited in claim 17, further comprising a step of:
forming at least a transparent conducting layer on an outer surface of the first substrate or second substrate.

19. The manufacturing method as recited in claim 18, wherein in the step of forming the at least a transparent conducting layer, the transparent conducting layer is a patterned polycrystalline transparent conducting layer, which is formed by the transformation of an amorphous transparent conducting layer.

20. The manufacturing method as recited in claim 19, in the step of forming the at least a transparent conducting layer, further comprising steps of:
forming the amorphous transparent conducting layer on a surface of the first substrate or second substrate;
patterning the amorphous transparent conducting layer by high energy pulse to make the patterned amorphous transparent conducting layer transformed into the patterned polycrystalline transparent conducting layer; and
removing the non-patterned amorphous transparent conducting layer by etching.
